(19) United States
(12) Patent Application Publication
(10) Pub. No.: US 2009/0047613 A1
(43) Pub. Date: Feb. 19, 2009

(54) Method and Apparatus for Pneumatic Drying of Lime Mud

(75) Inventors: Christopher L. Demler, Lebanon, OH (US); Tobin Alt, Cincinnati, OH (US); Kurt Skrifvars, Marietta, GA (US); Royce McCarty, West Chester, OH (US)

Correspondence Address: WEGMAN, HESSLER & VANDERBURG, 6055 ROCKSIDE WOODS BOULEVARD, SUITE 200, CLEVELAND, OH, 44131, US

(73) Assignee: Kadant Black Clawson Inc., Mason, OH (US)

(21) Appl. No.: 11/887,166

(22) PCT Filed: Mar. 21, 2006
(86) PCT No.: PCT/US2006/010268

§ 371 Date: Sep. 26, 2007

Related U.S. Application Data
(60) Provisional application No. 60/666,226, filed on Mar. 29, 2005.

(51) Int. Cl. F26B 17/10; F26B 23/02; F27B 7/20; F27B 7/42; F27D 19/00

(52) U.S. Cl. 432/17; 34/370; 432/32; 432/37; 432/69; 432/239; 432/105

(57) ABSTRACT

Method and apparatus for pneumatically drying thickened lime mud and feeding the dried thickened lime mud to a lime reburning kiln. The thickened mud is pneumatically dried via the action of flue gas emanating from the lime reburning kiln. The dried, thickened lime is separated from the flue gas in a cyclone separator. A process loop controller determines the temperature of the separated lime and, in response, controls the feed rate of lime fed to the pneumatic dryer to ensure that the dryer possesses the requisite latent heat needed to dry thickened lime therein. In one embodiment, the feed rate of lime fed to the thickener is adjustably controlled which, in turn, adjustably varies the flow rate of the thickened mud to the dryer.

### CROSS REFERENCE TO RELATED APPLICATION

This application claims the priority benefit of U.S. Provisional Patent Application Ser. No. 60/666,226 filed Mar. 29, 2005.

### FIELD OF THE INVENTION

The present invention pertains to a method and apparatus for pre-drying thickened lime mud in a pneumatic dryer so that the predried mud can then be fed directly to a lime reburning kiln.

### BACKGROUND OF THE INVENTION

The present invention relates to methods and apparatus in the field of reburning lime sludge in which lime sludge, largely CaCO₃, is regenerated to form active lime, CaO. In the pulp and paper industry, pulp is prepared by cooking wood under either the sulphate or soda method. The cooking process results in the dissolution of the major portion of the lignin components of the wood leaving a pulp fraction that is purified in a washing step. The washed pulp may be thereafter screened and bleached and is then fed to a dryer or directly to a paper mill.

The spent liquor from the washing step contains dissolved wood and the chemicals used during the cooking process. So that these chemicals can be recovered and reused, the spent liquor is normally concentrated via evaporation to remove most of the water content, and is burnt in a recovery boiler where the cooking chemical charge is recovered in the form of Na₂CO₃ in a green liquor.

So that the cooking chemicals can be recovered, the Na₂CO₃ present in the green liquor must be converted to NaOH. This is usually achieved by treatment of the green liquor with burnt lime CaO in the causticizing process to form a “white liquor” containing lime sludge. The reaction is as follows:

Na₂CO₃+CaO+H₂→2NaOH+CaCO₃

The calcium carbonate, CaCO₃, also known as lime sludge, is then converted into burnt lime, CaO, by the lime sludge reburning process which uses a rotary, lime sludge reburning kiln that typically operates at temperatures of about 1700-2100° F. In the rotary kiln, the lime sludge is subjected to the countercurrent flow of hot gas so that CaO is regenerated via the reaction

CaCO₃+heat→CaO+CO₂↑

Traditional lime reburning kilns have been large devices wherein the lime sludge entered at an upstream kiln end and was subjected to the action of rotary chains, baffles or the like to dry the lime mud as it proceeding through the kiln, with countercurrently flowing hot gases heating and calcining the sludge.

Recently, in order to minimize capital expenditures, lime reburning kilns have been made smaller with the lime mud subjected to a thickening step and subsequent preheating or drying step in a pneumatic dryer prior to feed into the lime reburning kiln. In the typical pneumatic dryer designs, hot flue gas from the lime reburning kiln was used as the heating and transport medium for the lime sludge with the thickened lime sludge and flue gas directed into a vertically disposed pneumatic dryer or conduit located proximate the flue gas exit from the kiln. The lime sludge heated in the pneumatic dryer was then separated from the flue gas in a cyclone or the like followed by feed of the separated, pre-dried lime sludge into the lime feed inlet end of the reburning kiln. Lime mud drying systems have been incorporated into the designs of new kilns to minimize capital expenditures. However, in the case of retrofits they are usually incorporated as a means to increase production and/or to reduce fuel cost.

One problem associated with such systems arose when the latent heat in the kiln flue gas was not great enough to evaporate the moisture content of the lime sludge fed to the pneumatic dryer. In these cases, clogging of the flue gas duct work and downstream separator could occur. Accordingly, there is a need in the art to minimize problems associated with convention lime mud reburning systems in which pneumatic dryers are employed to preheat lime mud prior to entry of the preheated or predried mud into the lime burning kiln.

### SUMMARY OF THE INVENTION

In accordance with the invention, a method for heat treating lime mud utilizing a pneumatic dryer and a reburning kiln is disclosed. The method comprises feeding lime mud to a thickener at a predetermined flow rate and thickening the lime mud in the thickener. The thickened lime mud is dried and preheated in a pneumatic dryer utilizing flue gases that are exhausted from the kiln. The thickened dried lime mud and flue gases are separated in a cyclone or the like. The temperature of the separated dried lime mud is determined either by direct measurement thereof in the cyclone or in proximity to the cyclone or by indirect measurement in which the temperature of the effluent flue gas from the separator is assessed. Then, the feed rate or amount of thickened lime mud fed to the pneumatic dryer is controlled so as to ensure that the latent heat in the dryer is sufficient to adequately dry the thickened lime mud therein. Such control can be made by adjustably regulating the feed rate of the lime mud fed to the lime mud thickener or by control of the operation of the lime mud thickener itself so that the amount of thickened lime mud exiting the thickener for transport to the pneumatic dryer is adjusted. This process control is correlated to and actuated by the measured temperature of the separated dried lime mud. The separated, dried lime mud is directed from the separator to the lime reburning kiln.

The apparatus disclosed is utilized to heat treat lime mud and includes a lime mud filter for thickening lime mud, a lime reburning kiln which includes a flue gas discharge, and a pneumatic drying conduit operatively connected to the lime reburning kiln for pneumatically preheating and drying thickened lime mud therein with the flue gas emanating from the flue gas discharge of the lime reburning kiln.

A separator, such as a cyclone separator, is connected to the pneumatic drying conduit to separate the preheated dried lime from the flue gas. The separated, predried lime mud is then fed to the upstream, lime mud entry end of the rotary, lime reburning kiln. A process loop controller is provided to control the feed rate of lime sludge ultimately fed to the pneumatic dryer in response to the temperature of the separated lime.

### DRAWING

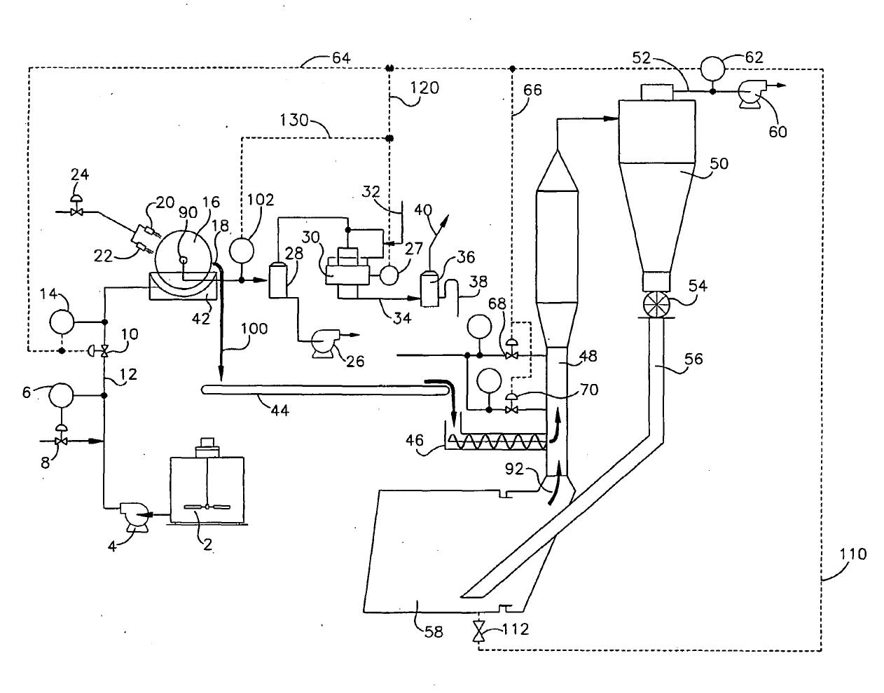

The invention will be further described in conjunction with the following appended drawing in which FIG. 1 is a diagrammatic drawing of the apparatus used for carrying out the method of the invention.

### DETAILED DESCRIPTION

Turning to the figure, there is shown a storage tank 2 with mixing vanes therein which is utilized to store and mix the lime sludge. A pump 4 pulls the lime sludge through the lime mud feed line 12 into the vat 42 of the lime sludge thickener (lime mud precoat filter) shown at 16.

A density sensor and control unit 6, such as a PLC (or a Distributive Control System (DCS), is operatively connected to an adjustable valve member such as a solenoid valve 8 so that make up water can, if desired, be fed to line 12 to control the density of the lime mud that is fed to the lime sludge thickener. A controllable valve 10 is shown in operative association with flow rate controller 14 so that the flow rate of lime mud fed to the lime sludge thickener 16 may be adjustably controlled.

As shown, the lime sludge thickener is of the type generally utilized throughout the industry as can be seen, for example, in U.S. Pat. No. 5,149,448. The entire disclosure of this patent is incorporated by reference. The lime sludge thickener is of the normal type in which a doctor or the like 18 scrapes thickened lime sludge from the rotating filter drum so that it drops via a gravity conveyor or the like 100 to a belt conveyor 44 disposed beneath the thickener.

The thickener is of the type in which a vacuum is drawn through manifold 90 via the action of the vacuum pump 30 acting through the vacuum receiver/separator 28. The vacuum acts to draw sludge from the vat 42 onto the drum where it will be thickened and subsequently removed from the drum via the action of doctor 18. The rotary drum thickener type 16 is the most common means of dewatering lime mud, but the skilled artisan will also appreciate that a disc type thickener can also be used in the process of dewatering lime mud for this application.

The vacuum pump 30 provides the force to the pull the slurry of lime mud, which is mostly CaCO₃ onto the drum where the dewatered lime mud is removed via the action of the doctor 18. The air that is pulled through the lime mud on the drum along with the water and soluble sodium compounds associated with the feed slurry are pulled through the manifold 90 and then into the receiver/separator 28. The receiver/separator 28 separates the liquid from the gas. The liquid drains by gravity to the filtrate pump 26, where it is pumped back into the recausticizing process. The gas that exits through the top of the receiver/separator 28 is pulled to the vacuum pump 30. As shown, the vacuum pump is a liquid ring type design and therefore requires water in order to generate its design vacuum pressure and flow rate. Water is fed to the vacuum pump via the water line 32. The water enters the pump and mixes with the gas (air) pulled through the lime mud filter. The combination of water and gas exits the vacuum pump 30 through line 34 into the discharge separator/silencer 36. The seal water and gas are separated in the separator/silencer 36. The water drains from the silencer from the line 38. The gas exits the silencer through exhaust pipe 40.

Water nozzles 20, 22 are provided and actuated via control valve 24 so as to apply a water jet to the circumference of the rotating mud on the drum. The nozzles function to wash soluble sodium compounds from the lime mud via displacement washing. These compounds if not reduced to an acceptable level in the dewatered lime discharged into the lime reburning kiln can cause excessive pollution emission and/or difficulty in lime kiln operation.

A screw conveyor 46 is located at the downstream end of belt conveyor 44 to convey thickened lime mud from the lime sludge thickener to a vertically disposed pneumatic drying conduit 48. The conduit 48 is provided in communication with the flue gas exit end of the lime reburning kiln 58. As can be seen in the drawing, flue gas exiting from the upstream end of the reburning kiln is shown at 92 and flows into the pneumatic drying conduit 48 to provide latent heat sufficient to evaporate the water content from the thickened lime sludge as same exits from the screw conveyor 46 into the pneumatic conduit 48. Typically, the lime sludge is thickened in the thickening device 16 so that it will contain from about 65-85% solids. Rotary vanes or other mixing baffles (not shown) may be disposed in the conduit 48 to increase the mixing turbulence and hence the heat transfer properties of the conduit.

The predried lime mud and flue gas travel upwardly through the conduit and are separated from each other in a cyclone 50 with the flue gas exiting via the gas duct 52 via the action of Induced Draft (ID) Fan 60. The predried, thickened and separated lime mud is passed through a rotary air lock 54 and is then gravity fed through conduit 56 to the lime reburning kiln 58. The purpose of the rotary air lock is to isolate the conduit 56 from the negative pressure at the point of the cyclone. As the pressure in the cyclone is more negative than at the back of the lime reburning kiln 58, without the rotary air lock 54 the dry lime dust separated in the cyclone would not flow down the conduit 56 and the cyclone would fill up with dried lime mud. As is conventional in the art, the lime mud will proceed downstream (toward the left hand direction shown in the figure) with the hot flue gases flowing in countercurrent fashion from left to right so as to calcine the lime mud in the reburning kiln and so that the flue gases exit as shown at 92 into the vertically disposed pneumatic drying conduit 48.

Effluent gas temperature monitor 62 is provided in operative association with effluent gas conduit 52 and communicates via process control line 64 with the feed control means 14 which controls the flow rate of the line mud from the storage tank 2 into the lime sludge thickener. The feed control means 14 is preferably a control valve in combination with a fixed speed pump or a variable speed pump without a control valve where the speed of the pump is varied in order to obtain the desired flow set point but the artisan will appreciate that a host of other controllers could be operatively associated with the effluent gas temperature monitor 62 and feed control means 14 to adjustably control the flow rate of lime mud from the storage vat 2 into the thickener 16. According to one aspect of the invention, when the temperature as sensed by monitor 62 falls below a first set point, for example about 300° F., then the feed rate of lime mud to the thickener 16 is decreased until the first set point temperature is achieved.

The effluent gas monitor 62 also is operatively connected with a proportioning controller 102 that can operate to selectively shut off vacuum pump motor 27. If the pump motor 27 is shut off, a vacuum will not be drawn through the manifold 90 so that the rotating drum will not be able to pick up any sludge from the vat 42. In effect, this will result in the cessation of the feed of thickened mud onto conveyor 44. This ultimately will result in an increase in the temperature of the gas measured at 62 and commensurate increase of temperature in the conduit 42. A second set point temperature of about 220° F. may be determined. If the temperature measured by monitor 62 falls below this second set point, communication with a controller operatively associated with pump 27 is made via control line 120, and the controller is actuated to turn off the pump. The cessation of the thickened mud into the dryer 48 can also be accomplished by the stopping the drive motor (not shown) for the rotary drum filter 16. There are several means to accomplish the cessation of the feed of the thickened mud into the dryer 48, however the elimination or reduction of the vacuum or in the case of a disc filter the positive pressure, is usually considered the least mechanically disruptive. It is also plausible and probable that by reversing the belt conveyor 44 that the cessation of thickened mud to the drying conduit can be accomplished.

It is noted that all of the equipment downstream of the thickener has a maximum operating temperature of about 750° F. In order for this temperature not to be exceeded, the system will also sense a third set point temperature at 62 and convey this information through process line 66 to adjustable spray nozzles 68, 70 to control the flow of water through the nozzles 68, 70 into the pneumatic drying conduit 48. When the monitor 62 assesses temperature at above 700° F., only one of the nozzles will be opened and produce an optimal spray flow pattern so as to slightly cool the pneumatic conduit. During conditions where the line mud feed is lost, which is a normal occurrence, such as when the lime mud filter is re-precoated, there is no mud feed to the pneumatic dryer. Since the back end temperature of the lime kiln will usually be about 1000-1400° F., this temperature will carry on through the ducting within a few seconds. In order to prevent damage to the downstream equipment the second nozzle system will open. A fourth set point of about 750° F. will be used to control the second nozzle. When this fourth set point is exceeded, maximum spray flow will be injected into the conduit to prevent damage to the system. A fifth set point of, for example, 800 F will be used to shut-off the fuel supply to the main burner of the rotary lime kiln 58. This is shown schematically in the drawing as process control line 110 that is in operative association with fuel supply valve 112. This interlock is the final means of preventing excessive temperature from damaging the drying system, cyclone, ID fan and electrostatic precipitator.

In another embodiment, process line 130 operatively connects proportioning controller 102 with pump motor 27 so as to vary the amount of vacuum impressed upon the lime sludge thickener 16. In this embodiment, a sixth temperature set point, for example, 680° F., could be set. If the temperature measured by monitor 62 exceeds this sixth set point, then the vacuum drawn on the filter could be reduced, ultimately resulting in a reduction of the cyclone exit temperature so that it does not exceed this set point. In this embodiment, it should be noted that the overall amount of lime mud fed to the thickener 16 should not applicably decrease.

One benefit to variable control of the vacuum drawn in filter 16 is the potential decrease in power consumption of the vacuum pump motor 27. The actual power consumption of this motor 27 is a function of its rotation rate and, if its maximum rotation rate is not required for the predetermined set lime mud feed rate to the thickener, then the power is wasted.

As the artisan will envision, this variable control loop may also be configured in such a way that its operation is independent from the cyclone exit temperature. In this regard, the loop 130 operatively connecting the proportioning device 102 to the pump motor 27 could be associated with a vacuum level detector or the like. A vacuum set point, for example, 20 inches Hg vacuum could be used as this set point, and the speed of the motor controlled to maintain this desired vacuum set point.

Upon review, it is seen that the temperature of the separated lime mud in the separator 50 is sensed, in the embodiment shown, by an indirect measurement of effluent gas through line 52. In turn, this temperature measurement controls the feed rate of the lime mud as it is fed to the lime mud thickener. A first set point, normally about 300° F. will be utilized for this control. That is, when the cyclone exit temperature drops below this first set point, the feed flow to the lime mud precoat filter will be decreased until this set point temperature. A second set point of about 220° F. will also be monitored. When the cyclone exit temperature drops below this second set point, the vacuum pump motor to the thickener will be stopped to eliminate all mud flow to the conduit 42. This will result in the temperature exiting the cyclone to increase above this set point. Again there are several means of stopping the flow of thickened lime mud to the drying conduit 48 and therefore any and all means of eliminating the flow of mud into the conduit 48, are included in this design. Eliminating the source of the motive force that allows the thickened lime mud to be drawn from the vat 42 is only one of these means.

Also, the temperature of the effluent flue gas flowing through line 52 is utilized to adjustably control the amount of spray emanating from the nozzles 68, 70 into the pneumatic drying conduit 48. As stated above, a third set point temperature is monitored and, when this third set point is exceeded controls flow through one of the nozzles. If a fourth set point is exceeded, both nozzles are opened providing maximum flow of cooling water into the pneumatic drying conduit 48. For example, one nozzle can be controlled so as to spray cooling water at a flow rate of about 0-15 gpm with a second nozzle being controlled to spray at a rate of from 15-50 gpm.

Although this invention has been described with respect to certain preferred embodiments, it will be appreciated that a wide variety of equivalents may be substituted for these specific elements shown and described herein, all without departing from the spirit and scope of the invention as defined in the appended claims.

What is claimed is:

1. A method for heat treating lime mud utilizing a pneumatic dryer and a reburning kiln comprising:
(a) feeding lime mud to a thickener;
(b) thickening said lime mud in said thickener;
(c) drying and preheating the thickened lime mud from said thickener in the pneumatic dryer utilizing flue gases exhausted from the kiln;
(d) separating the thickened dried lime from the flue gases;
(e) monitoring the temperature of the separated dried lime mud;
(f) controlling the feed rate of said thickened mud to said pneumatic dryer in response to said step (e); and
(g) feeding separated dried lime mud to said kiln.

2. A method as recited in claim 1 wherein said step (f) comprises controlling the feed rate of said lime mud to said thickener.

3. A method for heat treating lime mud utilizing a pneumatic dryer and a reburning kiln comprising:
(a) feeding lime mud to a thickener at a predetermined feed rate;
(b) thickening said lime mud in said thickener;
(c) drying and preheating the thickened lime mud from said thickener in the pneumatic dryer utilizing flue gases exhausted from the kiln;
(d) separating the thickened dried lime mud from the flue gases;
(e) monitoring the temperature of the separated dried lime mud;
(f) adjustably controlling the feed rate of said lime mud to said thickener in response to said step (e); and
(g) feeding the separated, dried lime mud to said kiln.

4. Method as recited in claim 3:
(a) wherein said step (e) comprises determining a desired first set point temperature for said separated dried lime mud and wherein said step (f) comprises reducing the feed rate of said lime mud fed to said thickener when the monitored temperature falls below said first set point temperature.

5. Method as recited in claim 4 wherein said step (d) comprises separating said dried and preheated lime mud and said flue gas in a cyclone separator.

6. Method as recited in claim 5 wherein said step (e) of monitoring the temperature of the separated dried lime mud comprises measuring the temperature of said dried lime mud.

7. Method as recited in claim 6 wherein said step (e) of monitoring the temperature of the separated dried lime mud comprises measuring the temperature of the flue gas exiting the cyclone.

8. Method as recited in claim 7 wherein said first set point temperature is from about 250° F.-500° F.

9. Method as recited in claim 8 wherein said predetermined feed rate is about 200-1000 gallons per minute.

10. Method as recited in claim 3 further comprising (h) feeding said thickened lime mud from said thickener to said pneumatic dryer and (i) selectively controlling the amount of thickened lime mud fed to said pneumatic dryer in response to said step (e).

11. Method as recited in claim 10 wherein said step (e) comprises determining a desired second set point temperature for said separated dried lime mud and wherein said step (i) comprises interrupting feed of said thickened lime mud from said thickener to said pneumatic dryer in response to said step (e) when said second set point temperature is not exceeded.

12. Method as recited in claim 3 further comprising:
(j) adjustably controlling cooling water flow into said pneumatic dryer.

13. Method as recited in claim 12 wherein said step (j) is performed in response to said step (e).

14. Method as recited in claim 13 wherein said step (e) further comprises determining a third set point temperature for said separated lime mud and wherein said step (j) comprises spraying from about 0-15 gpm of said cooling water into said pneumatic dryer when the monitored temperature rises above said third set point.

15. Method as recited in claim 14 wherein said step (e) further comprises determining a fourth set point temperature for said separated lime mud and wherein said step (j) comprises spraying from about 15-50 gpm of said cooling water into said pneumatic dryer when the monitored temperature rises above said fourth set point.

16. Method as recited in claim 15 wherein said step (e) further comprises determining a fifth set point temperature for said separated lime mud and in response (k) terminating fuel feed to said kiln when said fifth set point temperature is exceeded.

17. Method as recited in claim 16 further comprising providing a variable speed vacuum pump in operative association with said thickener to draw a vacuum through said thickener and (l) determining a sixth set point temperature for said separated lime mud and (m) adjustably controlling the amount of vacuum drawn through said thickener when said sixth set point temperature is exceeded.

18. Apparatus for heat treating lime mud comprising:
(a) a lime filter for thickening lime mud;
(b) a lime reburning kiln including a flue gas discharge;
(c) a pneumatic drying conduit operatively connected to said lime reburning kiln and said lime filter for pneumatically preheating and drying the thickened lime mud therein with heated flue gas from said flue gas discharge;
(d) a separator operatively connected to said pneumatic drying conduit to separate said preheated and dried lime mud from said flue gas;
(e) temperature monitoring means for monitoring temperature of said separated lime;
(f) control means responsive to said temperature monitoring means (e) for controlling the feed rate of lime fed to said pneumatic dryer; and
(g) separated lime feed means for feeding said separated lime to said lime reburning kiln.

19. Apparatus as recited in claim 18 further comprising a first conveyor means (h) for transporting thickened lime mud from said filter to said pneumatic drying conduit.

20. Apparatus as recited in claim 19 wherein said first conveyor means (h) comprises an upstream belt conveyor and a downstream screw conveyor.

21. Apparatus as recited in claim 18 wherein said separated lime feed means (g) comprises a gravity chute.

22. Apparatus as recited in claim 19 wherein said control means (f) comprise selective control means (i) for selectively controlling the amount of thickened lime mud fed to said first conveyor means (h) in response to said means (e).

23. Apparatus as recited in claim 18 further comprising cooling water flow control means (j) for adjustably controlling cooling water flow into said pneumatic drying conduit (c).

24. Apparatus as recited in claim 23 wherein said cooling water flow control means (j) is actuated by said means (e).

25. Apparatus as recited in claim 18 wherein said control means (f) comprises feed control means (k) for adjustably controlling the flow rate of said lime mud fed to said lime filter.

26. Apparatus as recited in claim 18 further comprising kiln shut off means (l) responsive to said temperature monitoring means (e) for selectively terminating fuel feed to said kiln.

27. Apparatus as recited in claim 18 wherein said feed control means (f) comprises a variable speed vacuum pump connected to said filter.
